(19) United States
(12) Patent Application Publication
(10) Pub. No.: US 2002/0130294 A1
(43) Pub. Date: Sep. 19, 2002

(54) Sewage sludge as fire suppressant

(76) Inventor: Guillermo Almagro, Corona, CA (US)

Correspondence Address: GUILLERMO ALMAGRO, 1453 Kirkwood Dr., Corona, CA, 92882, US

(21) Appl. No.: 09/771,610

(22) Filed: Jan. 30, 2001

(51) Int. Cl. C09K 3/00; A62D 1/00

(52) U.S. Cl. 252/2; 252/607

(57) ABSTRACT

A sewage sludge fire suppressant consisting of a wet cake solids is used to extinguish fires in building structures or on forest lands.

Every summer wild fires burn forest lands Western States due to lightning or other causes. This resulted in heavy losses in property, lives, and in timber land. In the year 2000 alone thousands of fire fighters, army personnel, and tanker planes from several States were recruited to help in fighting these wild fires. The higher ambient temperatures and lack of water made fire fighting difficult and fire fighters had resulted to burning of brush to cut off the spread of the fire.

I have discovered that sewage sludge wet cake when diluted with an equal volume of water can be pumped on the fire or dropped by plane or helicopter is very effective in putting out the fire.

### ELEMENTS OF A FIRE

There are three elements of a fire. viz. Fuel (carbon), availability of oxygen in air and temperature. In forest fires, the coniferous trees which contain rosin is very flammable. Furthermore, in dry weather the needles of pine trees, shrubbery or grass catch fire easily.

The availability of oxygen in air also increases the fierce action of the fire which is difficult to control when it is windy. In windy conditions the variable direction of the wind increases the possibility for the fire to spread in any direction.

### WATER GAS REACTION

What many firemen do not know is the influence of water in a fire. When the temperature of the fire reaches 900° F. the water reacts with the fuel or burning carbon to form carbon monoxide and hydrogen. See equation below.

C+H₂O⇄CO+H₂

2CO+O₂⇄2CO₂

2H₂+O₂⇄2H₂O

These two gases are very flammable. So, instead of the water putting out the fire, the fire gets hotter and no amount of water will put out the fire.

### SEWAGE SLUDGE

Sewage is normally collected in big cities and pumped into large tanks where it is inoculated with activated sludge in order to break down the organic substances into simple molecules such as hydrogen sulfide, carbon dioxide, or methane gas. Then, the sludge is treated with chlorine to destroy harmful bacteria. Finally, the sludge is filtered so that it can be discarded. However, the sludge consist of very fine particles and it is goes the filters very slowly. In order to speed up the flow of the sludge through the filters, it is first treated with a polymer (acrylamide and the like). The sludge particles attaches itself to the polymer so that the particles will no longer plug the pores of the filter cloth. The result is a semi-solid wet cake with a solids concentration of 10 to 13 percent.

In the aerial application of water as fire suppressant, it has been found that the water tend to atomize when dropped from substantial elevations. On the other hand, materials of high viscosity such as sewage sludge tend to resist atomization upon descent to target areas. The colloidal behavior of sewage sludge appears to effectively control or extinguish these fires.

### SUMMARY OF THE INVENTION

This invention is based on the discovery of a method of extinguishing a fire using a finely divided material such as colloidal sewage sludge. In accordance with this invention, the rapid extinguishing property of the sludge is brought about by the cooling effect of water which when applied on the fire causes the water to vaporize and leave a residual coating of the sludge on the burning material thereby shutting off the supply of oxygen to the burning material. The residual sewage sludge coating being poorly combustible prevents the burning material from further accelerating the burning process Unlike the water used, the sewage sludge sticks tenaciously on the burning surface and does not react with the carbon. This is also effective when applied to pine needles and other coniferous trees.

It has been found that sewage sludge, a waste product of sewage treatment plants in municipalities or cites, exhibit fire suppressant properties. The sludge prior to filtration is chlorinated to destroy microorganisms and other harmful bacteria, and then treated with a polymer to enhance its filterability. The final product from the filters come out as a black, gelatinous filter cake with a with a slight fetid odor. The solids concentration that is fed to the filters ranges from 1.0 to 3.0 per cent. The solids concentration that is obtained as filter cake ranges from 10 to 13 per cent.

It has been found that when the filter cake is spread on a piece of absorbent paper and dried to constant weight and then ignited, does not burn compared to the untreated paper used as control. This unexpected result shows that sewage sludge functions as an effective fire suppressant. Its fire suppressant property might be attributed to the chlorine or polymer used in the treatment of the sludge. Thus this sewage sludge may be used to put out fires, like forest fires or coal waste fires. A further advantage in using sewage sludge to control forest fires is its soil conditioning properties due to its organic matter content. It is also possible that his unusual behavior of sewage sludge might be attributed to the gelatinous character of the polymer used as filter aid as well as to the fine, colloidal behavior of the sludge itself. Thus when sewage filter cake is thinned with water and applied as fire suppressant to put out fires, the water will first vaporize due to the heat and high temperature of the fire. The sludge residue would then be deposited on the surface of the burning material, thereby preventing the oxygen from combining with the burning carbon. The result is that combustion stops. And because the sludge has a gelatinous consistency, it will spread uniformly on the burning surface even on pine needles. At low concentrations, say at 3 per cent solids, would still be effective since the deposition of sludge will build up as more of it is applied.

The economic benefits of using sewage sludge would be tremendous, inasmuch as, these products are waste by-products and, therefore, have very little economic value. Furthermore, insurance companies would benefit also since owners of damaged properties will have lesser claims and the result is that premiums would be reduced also if this sewage sludge suppressant is used by fire fighters.

It is, therefore, the primary object of this invention to provide a method of extinguishing a fire by the use of an aqueous suspension of finely divided solids such as sewage sludge that exhibit colloidal behavior in water.

Another object of this invention is to provide a method of extinguishing a burning structure, such as buildings.

Still another object of this invention is to provide a method of preventing combustion of coal waste fire in coal mines.

These and further objects of this invention will become apparent or be described thereof herein proceeds.

### DESCRIPTION OF THE INVENTION AND PREFERRED EMBODIMENTS

In a preferred embodiment, a suspension of sewage sludge is prepared to a concentration of approximately 5 to 6.5 per cent solids. The sludge was then tested for its fire suppressant properties. A test sample of untreated paper was used as control. The test sample of sewage sludge suspension applied on another test paper was dried to constant weight.

### EXAMPLE 1

A sample of the control was first used in the fire test. The untreated sample was placed on top of a wire screen (½″ square mesh), and then both ends were set on fire simultaneously using a lighted piece of paper, previously wetted with mineral spirits. The time of burning was determined.

### EXAMPLE 2

A similar piece of treated sample was also used in the fire test.

The treated sample was ignited next. The results are shown below.

TABLE 1
RESULTS OF SEWAGE SLUDGE TESTS

| | | |
|---|---|---|
| Sample | Burning Time, min. | % Solids |

| | | |
|---|---|---|
| 1 Control | 0.6 | 5 |
| 2 Treated | Charred, failed to burn | 5 |

The sample treated with sewage sludge did not burn probably due to exclusion of oxygen or air on the burning material. This goes to show that sewage sludge is an effective fire suppressant.

What is claimed are:

1. A method of suppressing fires comprising of applying an effective amount of a fire suppressant composition comprising a fine particulate gelatinous material such as sewage sludge applied to a flammable material in the environment to suppress said fire.

2. The method to claim 1, wherein said fire suppressant composition comprises a suspension of aqueous sewage sludge.

3. The method of claim 1, wherein said sewage sludge is applied to to said flammable material when said flammable material is burning.

4. The method of claim 1, wherein said flammable material comprises forest, shrubbery and grass.

5. The method of claim 1 wherein said fire suppressant composition is applied aerially or sprayed from a pump of a fire truck.
